(19) United States
(12) Patent Application Publication
(10) Pub. No.: US 2014/0359424 A1
(43) Pub. Date: Dec. 4, 2014

(54) METHOD AND APPARATUS FOR GENERATING WEB BROWSER LAUNCH PAGES

(71) Applicant: Tencent Technology (Shenzhen) Company Limited, Shenzhen (CN)

(72) Inventors: Xiaodan LIN, Shenzhen (CN); Jing LlU, Shenzhen (CN)

(73) Assignee: Tencent Technology (Shenzhen) Company Limited, Shenzhen (CN)

(21) Appl. No.: 14/181,275

(22) Filed: Feb. 14, 2014

Related U.S. Application Data
(63) Continuation of application No. PCT/CN2013/089270, filed on Dec. 12, 2013.

(30) Foreign Application Priority Data
May 28, 2013 (CN) 201310203916.2

(51) Int. Cl. G06F 3/0484; G06F 17/22

(52) U.S. Cl. CPC G06F 3/0484; G06F 17/2247
USPC 715/234; 715/760

(57) ABSTRACT

A method for generating a web browser launch page is performed at a computer. The computer receives a user input to start a web browser application. In response to the user input, the computer identifies a set of favorite website addresses defined by the user and a set of website addresses visited by the user during a predefined time period and determines, among them, a set of favorite website addresses visited by the user during the predefined time period. For each favorite website address, the computer determines a timestamp of a most recent visit by the user, a number of visits by the user during the predefined time period, and a current score of the favorite website address and generates a new score for the favorite website address. Finally, the computer displays the set of favorite website addresses in a first window in an order consistent with their scores.

### RELATED APPLICATIONS

This application is a continuation application of PCT Patent Application No. PCT/CN2013/089270, entitled “METHOD AND APPARATUS FOR GENERATING WEB BROWSER LAUNCH PAGES” filed Dec. 12, 2013, which claims priority to Chinese Patent Application No. 201310203916.2, “METHOD AND APPARATUS FOR GENERATING WEB BROWSER LAUNCH PAGES,” filed May 28, 2013, both of which are hereby incorporated by reference in their entirety.

### FIELD OF THE INVENTION

The present application relates to the field of Internet, and more particularly, to method and apparatus for generating web browser launch pages.

### BACKGROUND OF THE INVENTION

Now more and more users may acquire the latest information or interact with each other via the Internet, and what is essential is to open a browser to acquire a variety of information by browsing web pages; the browser herein may be a mobile phone browser, a desktop computer browser or a tablet computer browser.

In order to facilitate user operation, now various browsers are provided with a launch page when being opened, and a user can directly enter a website he wants to browse by clicking a website address in the launch page, without inputting the website address in the address bar of the browser.

The existing browser launch page generally includes website address navigation pages, quick link pages and the most commonly accessed pages. The website address navigation pages are hot website addresses commonly used by people or commercial website addresses provided by browser partners, and users usually cannot change website addresses in the website address navigation pages. The quick link pages are website addresses that are set by the users, and the users can easily browse, through the quick link pages, the websites they want to browse. For the most commonly accessed pages, generally, the browser provides users with a number of frequently accessed website addresses according to the frequency of accessing historical website address by the user, and the users can easily browse the website that they recently browse frequently through the most commonly accessed pages.

However, the above setting of the launch page especially the setting of the quick link pages and the most commonly accessed pages only takes website access frequency of the user into account, or requires the users to manually set the website addresses of their favorite website. If a user wants to set into the launch page a website address of a website which has a lower access frequency but is important, the user must manually set the website address of the website into the quick link page.

### SUMMARY

The above deficiencies and other problems associated with the conventional approach of generating web browser launch pages are reduced or eliminated by the invention disclosed below. In some embodiments, the invention is implemented in a computer system that has one or more processors, memory and one or more modules, programs or sets of instructions stored in the memory for performing multiple functions. Instructions for performing these functions may be included in a computer program product configured for execution by one or more processors.

One aspect of the present application involves a computer-implemented method performed at a computer having one or more processors and memory. The method includes: receiving a user input to start a web browser application; in response to the user input: identifying a set of favorite website addresses defined by the user and a set of website addresses visited by the user during a predefined time period; determining a set of favorite website addresses visited by the user during the predefined time period by cross-correlating the set of favorite website addresses defined by the user with the set of website addresses visited by the user during the predefined time period; for each favorite website address visited by the user during the predefined time period: determining a timestamp of a most recent visit by the user, a number of visits by the user during the predefined time period, and a current score of the favorite website address; and generating a new score for the favorite website address based, at least in part, on the timestamp, the number of visits, and the current score; and displaying the set of favorite website addresses visited by the user during the predefined time period in a first window of the web browser application in an order consistent with their respective newly-generated scores.

Another aspect of the present application involves a computer system. The computer system includes one or more processors, memory, and one or more programs stored in the memory and to be executed by the one or more processors. The one or more programs include instructions for: receiving a user input to start a web browser application; in response to the user input: identifying a set of favorite website addresses defined by the user and a set of website addresses visited by the user during a predefined time period; determining a set of favorite website addresses visited by the user during the predefined time period by cross-correlating the set of favorite website addresses defined by the user with the set of website addresses visited by the user during the predefined time period; for each favorite website address visited by the user during the predefined time period: determining a timestamp of a most recent visit by the user, a number of visits by the user during the predefined time period, and a current score of the favorite website address; and generating a new score for the favorite website address based, at least in part, on the timestamp, the number of visits, and the current score; and displaying the set of favorite website addresses visited by the user during the predefined time period in a first window of the web browser application in an order consistent with their respective newly-generated scores.

Another aspect of the invention involves a non-transitory computer readable storage medium having stored therein one or more programs for execution by one or more processors of a computer system, the one or more programs including instructions for: receiving a user input to start a web browser application; in response to the user input: identifying a set of favorite website addresses defined by the user and a set of website addresses visited by the user during a predefined time period; determining a set of favorite website addresses visited by the user during the predefined time period by cross-correlating the set of favorite website addresses defined by the user with the set of website addresses visited by the user during the predefined time period; for each favorite website address visited by the user during the predefined time period: determining a timestamp of a most recent visit by the user, a number of visits by the user during the predefined time period, and a current score of the favorite website address; and generating a new score for the favorite website address based, at least in part, on the timestamp, the number of visits, and the current score; and displaying the set of favorite website addresses visited by the user during the predefined time period in a first window of the web browser application in an order consistent with their respective newly-generated scores.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIG. 1 is a schematic structural view of an electronic device according to an embodiment of the present application;

FIG. 2 is a schematic structural view of a first preferred embodiment of a browser launch page generating apparatus according to some embodiments of the present application;

FIG. 3 is a flow chart of a first preferred embodiment of a browser launch page generating method according to some embodiments of the present application;

FIG. 4 is a schematic structural view of a second preferred embodiment of the web browser launch page generating apparatus according to some embodiments of the present application;

FIG. 5 is a flow chart of a second preferred embodiment of the web browser launch page generating method according to some embodiments of the present application;

FIG. 6 is a schematic structural view of a third preferred embodiment of the web browser launch page generating apparatus according to some embodiments of the present application;

FIG. 7 is a schematic structural view of a third preferred embodiment of the web browser launch page generating method according to some embodiments of the present application;

FIG. 8 is a schematic block diagram illustrating the relationship between two sets of website addresses associated with a web browser application according to some embodiments of the present application;

FIG. 9 is a schematic block diagram illustrating a data structure for storing website address related information according to some embodiments of the present application; and

FIGS. 10A-10C are screenshots illustrating how a web browser launch page is generated and updated according to some embodiments of the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The following embodiments are described with reference to the accompanying drawings, used to illustrate specific embodiments that can be implemented according to some embodiments of the present application.

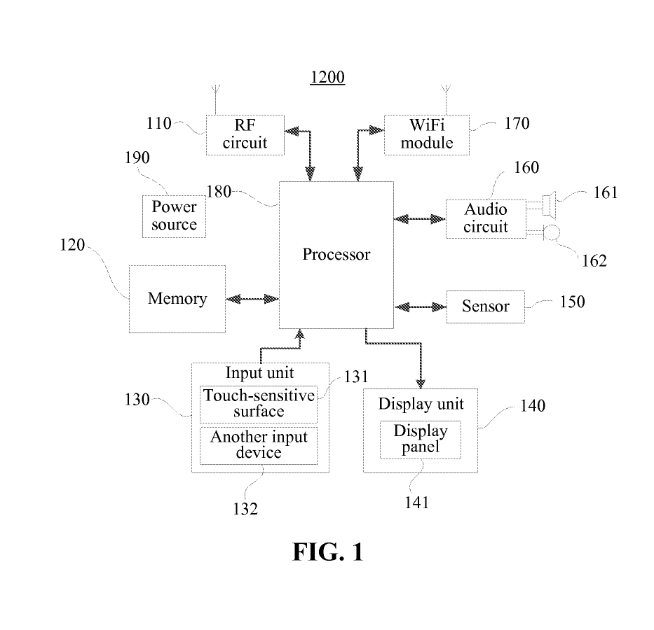

FIG. 1 is a schematic structural view of an electronic device according to an embodiment of the present application. Referring to FIG. 1, this embodiment of the present application provides an electronic device, which can be used for implementing a browser launch page generating method according to embodiments of the present application. Specifically, the electronic device is described in the following.

The electronic device 1200 may include a smart mobile phone, a tablet, an e-book reader, an MP4 (Moving Picture Experts Group Audio Layer IV) player, a portable laptop computer, a desktop computer, and the like. The electronic device 1200 may include components such as an RF (Radio Frequency) circuit 110, a memory 120 including one or more non-transitory computer-readable storage mediums, an input unit 130, a display unit 140, a sensor 150, an audio circuit 160, a WiFi (wireless fidelity, wireless transmission) module 170, a processor 180 including one or more processing cores, and a power source 190. Persons skilled in the art may understand that, the terminal structure shown in FIG. 1 does not limit the terminal, which may include components more or less than those illustrated, or combine some components, or have different component arrangements.

The RF circuit 110 may be used for receiving and sending signals during information receiving and sending or a call, particularly, after receiving downlink information of a base station, handing the information over to one or more processors 180 for processing; and in addition, sending data involving uplink to the base station. Usually, the RF circuit 110 includes, but is not limited to, an antenna, at least one amplifier, a tuner, one or more oscillators, a Subscriber Identity Module (SIM) card, a transceiver, a coupler, a Low Noise Amplifier (LNA), a duplexer, and the like. In addition, the RF circuit 110 may communicate with other devices via wireless communication and a network. The wireless communication may use any communication standard or protocol, which includes, but is not limited to, Global System of Mobile communication (GSM), General Packet Radio Service (GPRS), Code Division Multiple Access (CDMA), Wideband Code Division Multiple Access (WCDMA), Long Term Evolution (LTE), e-mails, Short Messaging Service (SMS), and the like.

The memory 120 may be used for storing software programs and modules, and the processor 180 executes various functional applications and data processing by running the software programs and modules stored in the memory 120. The memory 120 may mainly include a program storage region and a data storage region, where the program storage region may store an operating system, applications required by at least one function (such as a sound playback function, or an image playback function), and the like; the data storage region may store data (such as audio data, or phone book) created according to use of the electronic device 1200. In addition, the memory 120 may include a high-speed random access memory, and may also include a non-volatile memory, for example, at least one disk storage device, a flash memory device, or other volatile solid-state storage devices. Correspondingly, the memory 120 may also include a memory controller, to provide access of the processor 180 and the input unit 130 to the memory 120.

The input unit 130 may be used for receiving input numerical information or character information, and generating keyboard, mouse, joystick, optical or trackball signal input relevant to user setting and function control. Specifically, the input unit 130 may include a touch-sensitive surface 131 and another input device 132. The touch-sensitive surface 131, also called a touch screen or a touchpad, may collect a user touch operation thereon or nearby (e.g., user operation on the touch-sensitive surface 131 or near the touch-sensitive surface 131 with a finger, a stylus, and any other suitable object or accessory), and drive a corresponding connection device according to a preset program. Optionally, the touch-sensitive surface 131 may include a touch detection device and a touch controller. The touch detection device detects a position touched by the user, detects a signal brought about by the touch operation, and transmits the signal to the touch controller; the touch controller receives touch information from the touch detection device, converts it into a contact coordinate, and then sends the contact coordinate to the processor 180, and further can receive a command sent by the processor 180 and execute the command. In addition, the touch-sensitive surface 131 may be implemented with multiple types such as resistive, capacitive, infrared, and surface acoustic wave types. In addition to the touch-sensitive surface 131, the input unit 130 may also include another input device 132. Specifically, the other input device 132 may include, but is not limited to, one or more of a physical keyboard, a function key (such as volume control button, a switch button), a trackball, a mouse, and a joystick.

The display unit 140 may be used for displaying information input by the user or information provided for the user and various graphical user interfaces of the electronic device 1200, where the graphical user interfaces may be formed by graphics, texts, icons, videos, or any combination thereof. The display unit 140 may include a display panel 141, and optionally, the display panel 141 may be configured in forms such as a Liquid Crystal Display (LCD) or an Organic Light-Emitting Diode (OLED). Further, the touch-sensitive surface 131 may cover the display panel 141, and after detecting the touch operation thereon or nearby, the touch-sensitive surface 131 transmits it to the processor 180 to determine the type of the touch event, and then the processor 180 provides corresponding visual output on the display panel 141 according to the type of the touch event. Although in FIG. 1, the touch-sensitive surface 131 and the display panel 141 implement input and input functions as two separate members, in some embodiments, the touch-sensitive surface 131 and the display panel 141 can be integrated to implement input and output functions.

The electronic device 1200 may also include at least one sensor 150, for example, an optical sensor, a motion sensor, and other sensors. Specifically, the optical sensor may include an ambient light sensor and a proximity sensor, where the ambient light sensor may adjust brightness of the display panel 141 according to brightness of ambient light, and the proximity sensor may close the display panel 141 and/or backlight when the electronic device 1200 moves to the ear. As one kind of the motion sensor, a gravity accelerometer can detect the size of acceleration in various directions (generally triaxial), can detect the size and direction of gravity in the stationary state, and can be used for identifying applications of a phone posture (such as horizontal and vertical screen switching, related games, or magnetometer posture calibration), can vibrate to identify relevant functions (for example, a pedometer, or tapping), and the like; other sensors such as a gyroscope, a barometer, a hygrometer, a thermometer, and an infrared sensor that may be configured on the electronic device 1200 are not repeated herein.

An audio circuit 160, a loudspeaker 161, and a microphone 162 may provide an audio interface between the user and the electronic device 1200. The audio circuit 160 may convert received audio data into an electric signal, and then transmit the electric signal to the loudspeaker 161; and the loudspeaker 161 converts the electric signal into a sound signal for output. On the other hand, the microphone 162 converts the collected sound signal into an electric signal, and the audio circuit 160 receives the electric signal and then converts it into audio data; after being output to the processor 180 for processing, the audio data is sent to, for example, another terminal via the RF circuit 110, or the audio data is output to the memory 120 for further processing. The audio circuit 160 may further include an earplug jack, to provide communication between a peripheral headset and the electronic device 1200.

WiFi is a short-range wireless transmission technology, the electronic device 1200 can enable the user to send and receive an e-mail, browse webpages and access streaming media through the WiFi module 170, which provides wireless broadband Internet access for the users. Although FIG. 1 shows the WiFi module 170, but it may be understood that, the WiFi module 170 is not a necessary component of the electronic device 1200, and can be completely saved without changing the essential scope of the invention as required.

The processor 180 is a control center of the electronic device 1200, uses various interfaces and lines to connect various parts of the whole mobile phone, and executes various functions of the electronic device 1200 and processes data by running or executing software programs and/or modules stored in the memory 120, and invoking data stored in the memory 120, thereby monitoring the mobile phone as a whole. Optionally, the processor 180 may include one or more processing cores; preferably, the processor 180 may integrate an application processor and a modem processor, where the application processor mainly processes the operating system, user interfaces and applications, and the modem processor mainly processes wireless communication. It can be understood that, the modem processor may not be integrated into the processor 180.

The electronic device 1200 may also include a power source 190 (e.g., a battery) supplying power for various parts, and preferably, the power source can be logically connected with the processor 180 through a power management system, so as to achieve functions of managing charging, discharging, and power management through the power management system. The power source 190 may also include any component such as one or more DC or AC power sources, a recharging system, a power failure detection circuit, a power converter or inverter, or a power status indicator.

Although not shown, the electronic device 1200 may also include a camera, a Bluetooth module, and the like, which is not repeated herein. Specifically, in this embodiment, the display unit of the electronic device 1200 is a touch screen display, and the electronic device 1200 may include a memory and one or more programs, where the one or more programs correspond to the web browser launch page generating apparatus according to the embodiment of the present application, are stored in the memory, and are configured to implement through one or more processors the web browser launch page generating apparatus according to the embodiment of the present application to execute the web browser launch page generating method according to the embodiment of the present application.

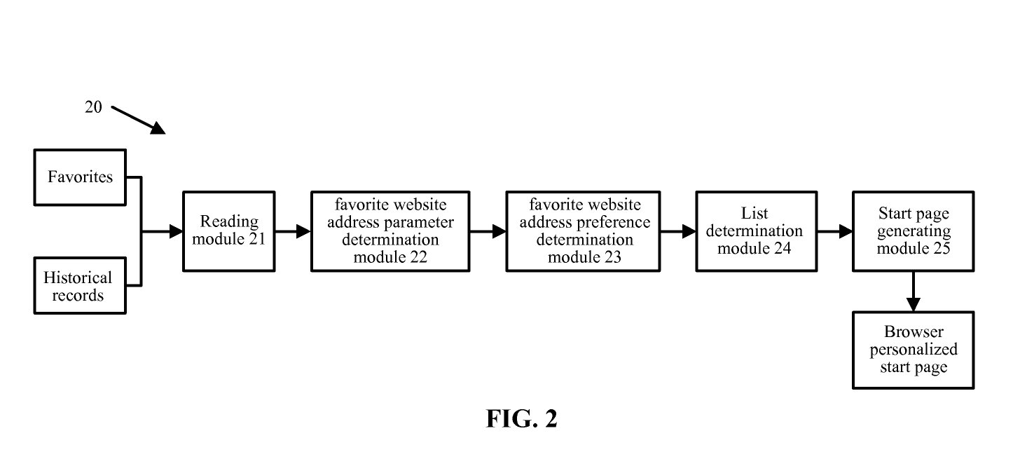

FIG. 2 is a schematic structural view of a first preferred embodiment of a browser launch page generating apparatus according to some embodiments of the present application. Referring to FIG. 2, a browser launch page generating apparatus 20 in this preferred embodiment is disposed in the electronic device 1200, includes a reading module 21, a favorite website address parameter determination module 22, a favorite website address preference determination module 23, a list determination module 24, and a launch page generating module 25.

The reading module 21 is used for reading favorite website addresses in the Favorites of the browser and historical records of accessing the website addresses within a predefined time period; the favorite website address parameter determination module 22 is used for determining, according to the historical records of accessing the website addresses within a predefined time period, a frequency of accessing a favorite website address in the predefined time period and recent access time of the favorite website address; the favorite website address preference determination module 23 is used for determining, according to the frequency of accessing the favorite website address in the predefined time period, the recent access time of the favorite website address, and a Favorites preset coefficient, a score of the favorite website address; the list determination module 24 is used for determining, according to the score of the favorite website address and the set number of launch page website addresses in a browser launch page, a list of launch page website addresses set in the web browser launch page; and the launch page generating module 25 is used for generating a browser launch page according to the list of launch page website addresses.

In use of the web browser launch page generating apparatus 20 in this preferred embodiment, the reading module 21 first reads the favorite website addresses in the Favorites of the browser and the historical records of accessing the website addresses within the predefined time period. A user can save into the favorite website addresses of websites that the user wants to set in a personalized launch page, so that the user can acquire parameters of the favorite website addresses through the historical records of accessing the website addresses, thereby determining which favorite website addresses are set in the personalized launch page, where the predefined time period herein can be set according to the requirements of the user, such as one weak, one month, or three months.

As the access frequency and the recent access time can well reflect preference of the user to the favorite website addresses (that is, the user may frequently access the favorite website addresses in a recent period of time), the favorite website address parameter determination module 22 determines, according to the historical records of accessing the website addresses within the predefined time period read by the reading module 21, a frequency of accessing a favorite website address in the predefined time period and the recent access time of the favorite website address.

Then, the favorite website address preference determination module 23 determines, according to the frequency of accessing a favorite website address in the predefined time period and the recent access time of the favorite website address determined by the favorite website address parameter determination module 22, and the Favorites preset coefficient, a score of the favorite website address. The Favorites preset coefficient is a preset constant, and a formula of calculating the score of a specific favorite website address may be as follows:

Rᵢ=α×Tᵢ×Uᵢ

where Rᵢ is the score of the favorite website address i, α is the Favorites preset coefficient, Tᵢ is a reciprocal of a difference between the recent access time of the favorite website address i and the current time, and Uᵢ is the frequency of accessing the favorite website address i in the predefined time period.

In this way, the favorite website address preference determination module 23 can determine a score of the favorite website address. Here, it should be noted that, there may be many manners of setting a relationship between the score of the favorite website address and the recent access time of the favorite website address, and a relationship between the score and the frequency of accessing the favorite website address in the predefined time period. Generally, the closer the recent access time of the favorite website address is to the current time, the higher the score of the favorite website address is; the greater the frequency of accessing the favorite website address in the predefined time period is, the higher the score of the favorite website address is. If it is necessary to increase an effect of the recent access time of the favorite website address on the score of the favorite website address, Rᵢ=α×Tᵢ²×Uᵢ can be set, and if it is necessary to increase an effect of the frequency of accessing the favorite website address in the predefined time period on the score of the favorite website address, Rᵢ=α×Tᵢ×Uᵢ² can be set. Therefore, different formulas of calculating a score of a specific favorite website address do not affect the protection scope of the embodiments of the present application.

Afterwards, the list determination module 24 determines, according to the score of the favorite website address determined by the favorite website address preference determination module 23 and the set number of launch page website addresses in the web browser launch page, a list of launch page website addresses set in the web browser launch page, and generally may set favorite website addresses in the list of launch page website addresses in the web browser launch page according to scores of the favorite website addresses in a descending order of the scores.

Finally, the launch page generating module 25 generates a browser launch page according to the list of launch page website addresses determined by the list determination module 24, and in this way, the web browser launch page generating apparatus 20 in this preferred embodiment completes the whole browser launch page generating process.

The web browser launch page generating apparatus in this preferred embodiment determines, according to access frequency parameters and access time parameters related to the favorite website addresses, launch page website addresses in a browser launch page, thereby improving webpage browsing efficiency of the user.

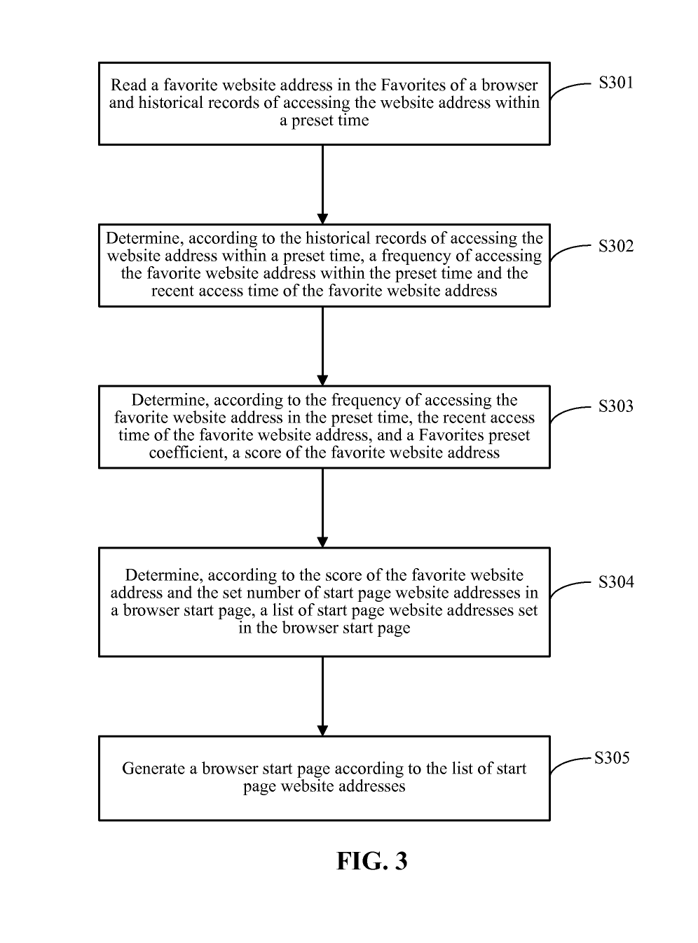

FIG. 3 is a flow chart of a first preferred embodiment of a browser launch page generating method according to some embodiments of the present application. Referring to FIG. 2 and FIG. 3, the web browser launch page generating method according to this preferred embodiment includes the following steps.

Step S301: Read a favorite website address in the Favorites of a browser and historical records of accessing the website address within a predefined time period.

Step S302: Determine, according to the historical records of accessing the website address within a predefined time period, a frequency of accessing the favorite website address within the predefined time period and the recent access time of the favorite website address.

Step S303: Determine, according to the frequency of accessing the favorite website address in the predefined time period, the recent access time of the favorite website address, and a Favorites preset coefficient, a score of the favorite website address.

Step S304: Determine, according to the score of the favorite website address and the set number of launch page website addresses in a browser launch page, a list of launch page website addresses set in the web browser launch page.

Step S305: Generate a browser launch page according to the list of launch page website addresses.

The web browser launch page generating method according to this preferred embodiment ends at Step S305.

Steps of the web browser launch page generating method according to this preferred embodiment are described below in detail.

In Step S301, the reading module 21 reads the favorite website address in the Favorites of the browser and the historical records of accessing the website address within the predefined time period. The user can save into the favorite website addresses of websites that the user wants to set in a personalized launch page, so that the user can acquire parameters of the favorite website addresses through the historical records of accessing the website addresses, thereby determining which favorite website addresses are set in the personalized launch page, where the predefined time period herein can be set according to requirements of the user, such as one weak, one month, or three months.

Then Step S302 is performed.

In Step S302, as the access frequency and the recent access time can well reflect reference of the user to the favorite website address (that is, a user may frequently access the favorite website address in a recent period of time), in this step, the favorite website address parameter determination module 22 determines, according to the historical records of accessing the website address within the predefined time period read by the reading module 21, a frequency of accessing the favorite website address in the predefined time period and the recent access time of the favorite website address.

Then Step S303 is performed.

In Step S303, the favorite website address preference determination module 23 determines, according to the frequency of accessing the favorite website address in the predefined time period and the recent access time of the favorite website address determined by the favorite website address parameter determination module 22, and a Favorites preset coefficient, a score of the favorite website address. The Favorites preset coefficient is a preset constant, and a formula of calculating a score of a specific favorite website address may be as follows:

Rᵢ=α×Tᵢ×Uᵢ

where Rᵢ is the score of the favorite website address i, α is the Favorites preset coefficient, Tᵢ is a reciprocal of a difference between the recent access time of the favorite website address i and the current time, and Uᵢ is the frequency of accessing the favorite website address i in the predefined time period.

In this way, the favorite website address preference determination module 23 can determine a score of the favorite website address. Here, it should be noted that, there may be many manners of setting a relationship between the score of the favorite website address and the recent access time of the favorite website address, and a relationship between the score and the frequency of accessing the favorite website address in the predefined time period. Generally, the closer the recent access time of the favorite website address is to the current time, the higher the score of the favorite website address is; the greater the frequency of accessing the favorite website address in the predefined time period is, the higher the score of the favorite website address is. If it is necessary to increase an effect on of the recent access time of the favorite website address on the score of the favorite website address, Rᵢ=α×Tᵢ²×Uᵢ can be set, and if it is necessary to increase an effect of the frequency of accessing the favorite website address in the predefined time period on the score of the favorite website address, Rᵢ=α×Tᵢ×Uᵢ² can be set. Therefore, different formulas of calculating a score of a specific favorite website address do not affect the protection scope of the embodiments of the present application.

Afterwards, Step S304 is performed.

In Step S304, the list determination module 24 determines, according to the score of the favorite website address determined by the favorite website address preference determination module 23 and the set number of launch page website addresses in a browser launch page, a list of launch page website addresses set in the web browser launch page, and generally may set the favorite website addresses in the list of launch page website addresses in the web browser launch page according to scores of the favorite website addresses in a descending order of the scores.

Then Step S305 is performed.

In Step S305, the launch page generating module 25 generates a browser launch page according to the list of launch page website addresses determined by the list determination module 24.

In this way, the whole browser launch page generating process is completed.

The web browser launch page generating method in this preferred embodiment determines, according to access frequency parameters and access time parameters related to the favorite website addresses, launch page website addresses in a browser launch page, thereby improving webpage browsing efficiency of the user.

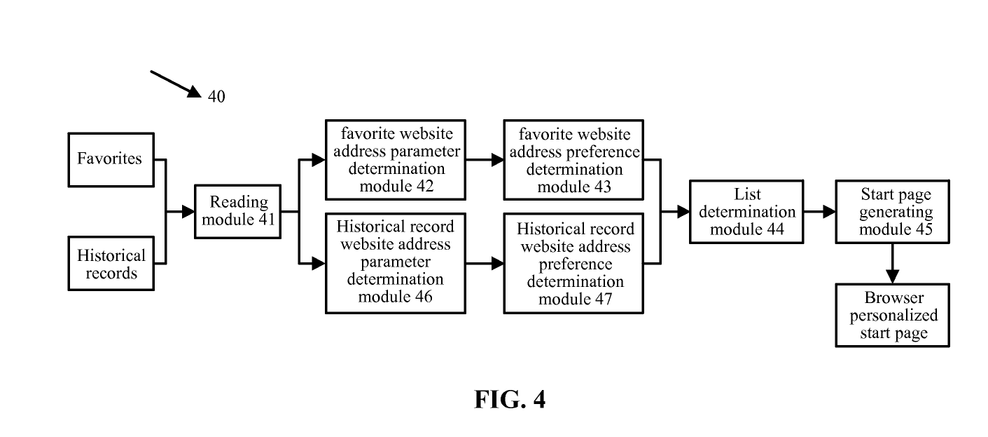

FIG. 4 is a schematic structural view of a second preferred embodiment of the web browser launch page generating apparatus according to some embodiments of the present application. Referring to FIG. 4, a browser launch page generating apparatus 40 in this preferred embodiment may also be set in the electronic device 1200, and includes a reading module 41, a favorite website address parameter determination module 42, a favorite website address preference determination module 43, a historical record website address parameter determination module 46, a historical record website address preference determination module 47, a list determination module 44, and a launch page generating module 45.

The difference between this preferred embodiment and the first preferred embodiment of the web browser launch page generating apparatus lies in that, the web browser launch page generating apparatus 40 further includes a historical record website address parameter determination module 46 and a historical record website address preference determination module 47. The historical record website address parameter determination module 46 is used for determining, according to historical records of accessing the website addresses within a predefined time period, a frequency of accessing historical record website addresses in the historical records within the predefined time period and the recent access time of the historical record website addresses; the historical record website address preference determination module 47 is used for determining, according to the frequency of accessing the historical record website addresses within the predefined time period, the recent access time of the historical record website addresses, and a historical record preset coefficient, scores of the historical record website addresses; and the list determination module 44 is specifically used for determining, according to the scores of the historical record website addresses, the score of the favorite website address, and the set number of launch page website addresses in a browser launch page, a list of launch page website addresses set in the web browser launch page.

In use of the web browser launch page generating apparatus 40 in this preferred embodiment, the reading module 41 first reads the favorite website addresses in the Favorites of the browser and the historical records of accessing the website addresses within the predefined time period.

Afterwards, the favorite website address parameter determination module 42 determines, according to the historical records of accessing the website addresses within the predefined time period read by the reading module 41, a frequency of accessing a favorite website address in the predefined time period, and the recent access time of the favorite website address. Meanwhile, the historical record website address parameter determination module 46 determines, according to the historical records of accessing the website addresses within a predefined time period read by the reading module 41, a frequency of accessing historical record website addresses in the historical records within the predefined time period and the recent access time of the historical record website addresses. In this way, parameters of all website addresses of websites recently browsed can be acquired through the historical records of accessing the website addresses, so that the user can judge, by reading the frequency of accessing website addresses in the historical records and the recent access time, which historical record website addresses in the historical records are website addresses of websites that the user may frequently access in a recent period of time, even if the users do not save into the Favorites the website addresses of the websites they want to set in the personalized launch page (or forgets to save them into the Favorites), thereby further facilitating user operations and strengthening intelligentization of the website addresses of the websites in the personalized launch page.

Then, the favorite website address preference determination module 43 determines, according to the frequency of accessing a favorite website address in the predefined time period and the recent access time of the favorite website address determined by the favorite website address parameter determination module 42 and a Favorites preset coefficient, a score of the favorite website address. Meanwhile, the historical record website address preference determination module 47 determines, according to the frequency of accessing historical record website addresses within the predefined time period and the recent access time of the historical record website addresses determined by the historical record website address parameter determination module 46 and a historical record preset coefficient, scores of the historical record website addresses.

The historical record website addresses include all favorite website addresses, the historical record preset coefficient is also a preset constant, and the Favorites preset coefficient is often set to be greater than the historical record preset coefficient, so that scores of favorite website addresses having the same access frequency in the predefined time period and the same recent access time are greater than those of the historical record website addresses. The method for calculating a score of a specific favorite website address is as that stated in the first preferred embodiment of the web browser launch page generating apparatus.

A formula of calculating a score of a specific historical record website address may be as follows:

Rⱼ=α′×Tⱼ×Uⱼ

where Rⱼ is the score of the historical record website address j, α is the historical record preset coefficient, Tⱼ is a reciprocal of a difference between the recent access time of the historical record website address j and the current time, and Uⱼ is the frequency of accessing the historical record website address j in the predefined time period.

In this way, the historical record website address preference determination module 47 can determine a score of a historical record website address. Here, it should be noted that, there may be many manners of setting a relationship between the score of the historical record website address and the recent access time of the historical record website address, and a relationship between the score and the frequency of accessing the historical record website address in the predefined time period. Generally, the closer the recent access time of the historical record website address is to the current time, the higher the score of the historical record website address is; the greater the frequency of accessing the historical record website address in the predefined time period is, the higher the score of the historical record website address is. If it is necessary to increase an effect of the recent access time of the historical record website address on the score of the historical record website address, Rⱼ=α×Tⱼ²×Uⱼ can be set, and if it is necessary to increase an effect of the frequency of accessing the favorite website address in the predefined time period on the score of the historical record website address, Rⱼ=α×Tⱼ×Uⱼ² can be set. Therefore, different formulas of calculating a specific score of a historical record website address do not affect the protection scope of the embodiments of the present application.

Afterwards, the list determination module 44 determines, according to the score of the historical record website address determined by the historical record website address preference determination module 47, the score of the favorite website address determined by the favorite website address preference determination module 43 and the set number of launch page website addresses in a browser launch page, a list of launch page website addresses set in the web browser launch page. Generally, the favorite website addresses and the historical record website addresses may be set in the list of launch page website addresses in the web browser launch page according to the scores in a descending order of the scores.

Finally, the launch page generating module 45 generates a browser launch page according to the list of launch page website addresses determined by the list determination module 44, and in this way, the web browser launch page generating apparatus 40 in this preferred embodiment completes the whole browser launch page generating process.

The web browser launch page generating apparatus in this preferred embodiment determines, according to access frequency parameters and access time parameters related to the favorite website addresses and the historical record website addresses, launch page website addresses in a browser launch page, thereby improving webpage browsing efficiency of the user.

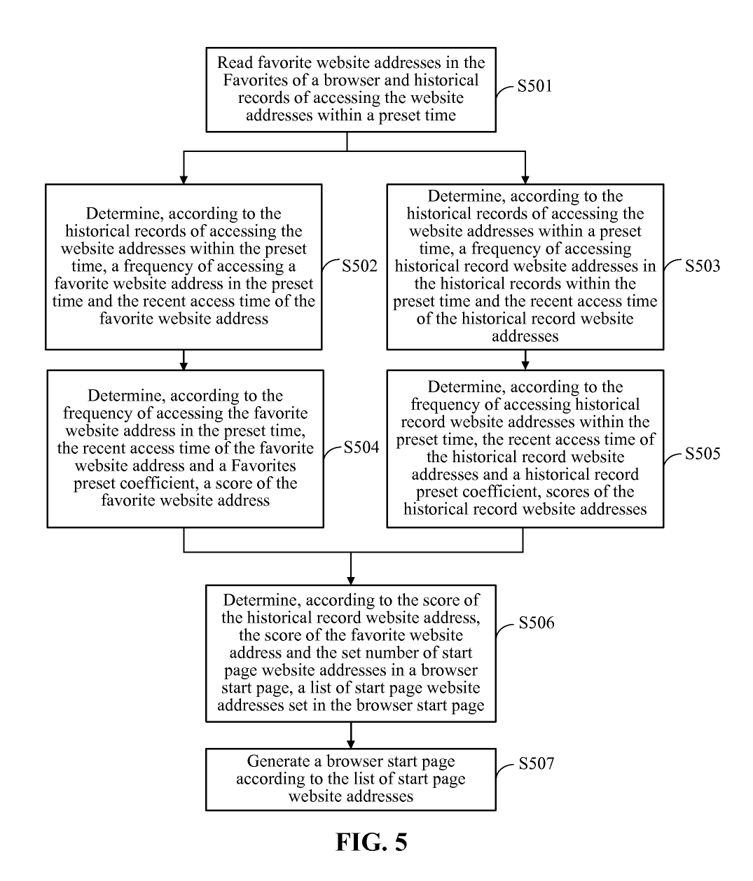

FIG. 5 is a flow chart of a second preferred embodiment of the web browser launch page generating method according to some embodiments of the present application. Referring to FIG. 4 and FIG. 5, the web browser launch page generating method in this preferred embodiment includes the following steps.

Step S501: Read favorite website addresses in Favorites of the browser and historical records of accessing the website addresses within a predefined time period.

Step S502: Determine, according to the historical records of accessing the website addresses within the predefined time period, a frequency of accessing a favorite website address in the predefined time period and the recent access time of the favorite website address.

Step S503: Determine, according to the historical records of accessing the website addresses within a predefined time period, determining a frequency of accessing historical record website addresses in the historical records within the predefined time period and the recent access time of the historical record website addresses.

Step S504: Determine, according to the frequency of accessing a favorite website address in the predefined time period, the recent access time of the favorite website address, and a Favorites preset coefficient, a score of the favorite website address.

Step S505: Determine according to the frequency of accessing historical record website addresses within the predefined time period, the recent access time of the historical record website addresses, and a historical record preset coefficient, scores of the historical record website addresses.

Step S506: Determine, according to the scores of the historical record website addresses, the score of the favorite website address, and the set number of launch page website addresses in a browser launch page, a list of launch page website addresses set in the web browser launch page.

Step S507: Generate a browser launch page according to the list of launch page website addresses.

The web browser launch page generating method according to this preferred embodiment ends at Step S507.

Steps of the web browser launch page generating method according to this preferred embodiment are described below in detail.

The principle of step S501 is identical with or similar to that in step S301 of the first preferred embodiment of the web browser launch page generating method; please refer to relevant description in step S301 of the first preferred embodiment of the web browser launch page generating method for details.

Then step S502 and step S503 are performed.

The principle of step S502 is identical with or similar to that in step S302 of the first preferred embodiment of the web browser launch page generating method; please refer to relevant description in step S302 of the first preferred embodiment of the web browser launch page generating method for details.

In step S503, the historical record website address parameter determination module 46 determines, according to the historical records of accessing the website addresses within a predefined time period read by the reading module 41, a frequency of accessing historical record website addresses in the historical records within the predefined time period and the recent access time of the historical record website addresses. In this way, parameters of all website addresses of websites recently browsed can be acquired through the historical records of accessing the website addresses, so that the user can judge, by reading the frequency of accessing the website addresses in the historical records and the recent access time, which historical record website addresses in the historical records are website addresses of the websites that the users may frequently access in a recent period of time, even if the user do not save into the Favorites the website addresses of the websites they want to set in the personalized launch page (or forgets to save them into the Favorites), which further facilitates user operation and strengthens intelligentization of the website addresses of the personalized launch page.

Then step S504 and step S505 are performed.

The principle of step S504 is identical with or similar to that in step S303 of the first preferred embodiment of the web browser launch page generating method; please refer to relevant description in step S303 of the first preferred embodiment of the web browser launch page generating method for details.

In step S505, the historical record website address preference determination module 47 determines, according to the frequency of accessing historical record website addresses within the predefined time period and the recent access time of the historical record website addresses determined by the historical record website address parameter determination module 46, and a historical record preset coefficient, scores of the historical record website addresses.

The historical record website addresses include all favorite website addresses, the historical record preset coefficient is also a preset constant, and the Favorites preset coefficient is often set to be greater than the historical record preset coefficient, so that scores of favorite website addresses having the same access frequency in the predefined time period and the same recent access time are greater than those of the historical record website addresses. A formula of calculating a score of a specific historical record website address may be as follows:

Rⱼ=α′×Tⱼ×Uⱼ

where Rⱼ is the score of the historical record website address j, α′ is the historical record preset coefficient, Tⱼ is a reciprocal of a difference between the recent access time of the historical record website address j and the current time, and Uⱼ is the frequency of accessing the historical record website address j in the predefined time period.

In this way, the historical record website address preference determination module 47 can determine a score of a historical record website address. Here, it should be noted that, there may be many manners of setting a relationship between the score of the historical record website address and the recent access time of the historical record website address, and a relationship between the score and the frequency of accessing the historical record website address in the predefined time period. Generally, the closer the recent access time of the historical record website address is to the current time, the higher the score of the historical record website address is; the greater the frequency of accessing the historical record website address in the predefined time period is, the higher the score of the historical record website address is. If it is necessary to increase an effect of the recent access time of the historical record website address on the score of the historical record website address, Rⱼ=α×Tⱼ²×Uⱼ can be set, and if it is necessary to increase an effect of the frequency of accessing the favorite website address in the predefined time period on the score of the historical record website address, Rⱼ=α×Tⱼ×Uⱼ² can be set. Therefore, different formulas of calculating a specific score of a historical record website address do not affect the protection scope of the embodiments of the present application.

Afterwards, step S506 is performed.

In step S506, the list determination module 44 determines, according to the score of the historical record website address determined by the historical record website address preference determination module 47, the score of the favorite website address determined by the favorite website address preference determination module 43, and the set number of launch page website addresses in a browser launch page, a list of launch page website addresses set in the web browser launch page. Generally, the favorite website addresses and the historical record website addresses may be set in the list of launch page website addresses in the web browser launch page according to the scores in a descending order of the scores.

Then step S507 is performed.

In step S507, the launch page generating module 45 generates a browser launch page according to the list of launch page website addresses determined by the list determination module 44.

In this way, the whole browser launch page generating process in this preferred embodiment is completed.

The web browser launch page generating method in this preferred embodiment determines, according to access frequency parameters and access time parameters related to favorite website addresses and historical record website addresses, launch page website addresses in a browser launch page, thereby improving webpage browsing efficiency of the user.

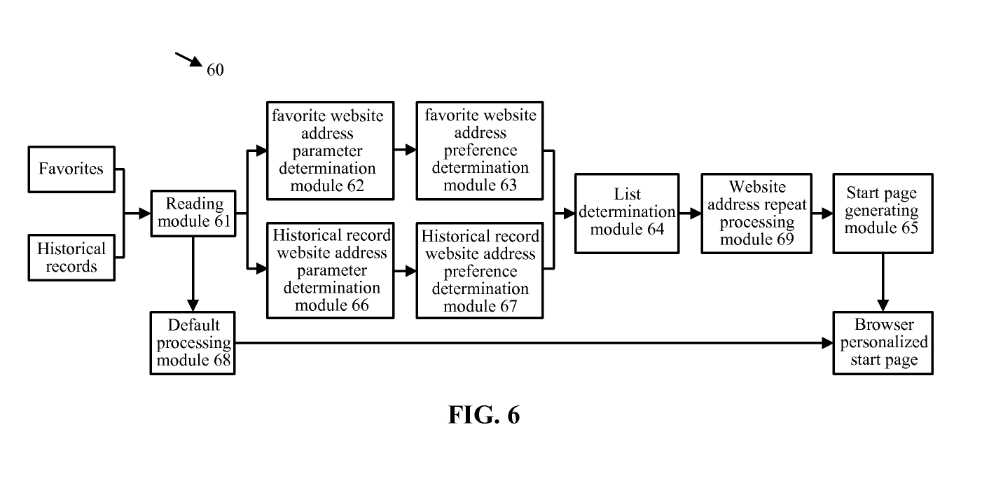

Referring to FIG. 6, FIG. 6 is a schematic structural view of a third preferred embodiment of the web browser launch page generating apparatus according to some embodiments of the present application. A browser launch page generating apparatus 60 in this preferred embodiment is set in the electronic device 1200, and includes a reading module 61, a default processing module 68, a favorite website address parameter determination module 62, a favorite website address preference determination module 63, a historical record website address parameter determination module 66, a historical record website address preference determination module 67, a list determination module 64, a website address repeat processing module 69, and a launch page generating module 65.

The difference between this preferred embodiment and the second preferred embodiment of the web browser launch page generating apparatus lies in that, the web browser launch page generating apparatus 60 further includes a default processing module 68 and a website address repeat processing module 69. The default processing module 68 is used for generating a default browser launch page or a blank page if it is read that the favorite website addresses in the Favorites of the browser are empty; the website address repeat processing module 69 is used for, if historical record website addresses in the list of launch page website addresses and the favorite website addresses repeat, deleting the repeated historical record website addresses from the list of launch page website addresses; further, the website address repeat processing module 69 may also supplement launch page website addresses in the list of launch page website addresses according to the scores of the historical record website addresses and the scores of the favorite website addresses.

In use of the web browser launch page generating apparatus in this preferred embodiment, the reading module 61 first reads the favorite website addresses in the Favorites of the browser and the historical records of accessing the website addresses within the predefined time period. If the reading module 61 reads that the favorite website addresses in the Favorites of the browser or the historical records of accessing the website addresses within the predefined time period are empty, the default processing module 68 generates a default browser launch page or a blank page. As the favorite website addresses in the Favorites of the browser or the historical records of accessing the website addresses within the predefined time period being empty will result in that the scores of the favorite website addresses cannot be acquired, the configuration of the default processing module 68 can avoid an error in the generation of a browser launch page when the above situation takes place.

Then, the favorite website address parameter determination module 62 determines, according to the historical records of accessing the website addresses within the predefined time period read by the reading module 61, a frequency of accessing a favorite website address in the predefined time period and the recent access time of the favorite website address. Meanwhile, the historical record website address parameter determination module 66 determines, according to the historical records of accessing the website addresses within a predefined time period read by the reading module 61, a frequency of accessing historical record website addresses in the historical records within the predefined time period and the recent access time of the historical record website addresses.

Then, the favorite website address preference determination module 63 determines, according to the frequency of accessing the favorite website address in the predefined time period and the recent access time of the favorite website address determined by the favorite website address parameter determination module 62 and a Favorites preset coefficient, a score of the favorite website address. Meanwhile, the historical record website address preference determination module 67 determines, according to the frequency of accessing historical record website addresses within the predefined time period and the recent access time of the historical record website addresses determined by the historical record website address parameter determination module 66 and a historical record preset coefficient, scores of the historical record website addresses.

Afterwards, the list determination module 64 determines, according to the score of the historical record website address determined by the historical record website address preference determination module 67, the score of the favorite website address determined by the favorite website address preference determination module 63 and the set number of launch page website addresses in a browser launch page, a list of launch page website addresses set in the web browser launch page. Generally, the favorite website addresses and the historical record website addresses may be set in the list of launch page website addresses in the web browser launch page in a descending order of the scores.

Then the website address repeat processing module 69 judges whether the historical record website addresses in the list of launch page website addresses and the favorite website addresses repeat, and if the historical record website addresses in the list of launch page website addresses and the favorite website addresses repeat, the website address repeat processing module deletes the repeated historical record website addresses from the list of launch page website addresses (as scores of the repeated historical record website addresses are generally lower than those of repeated favorite website addresses, the historical record website addresses with lower scores are deleted from the list of launch page website addresses herein), so as to avoid that repetition occurs in the launch page website addresses in the web browser launch page. Further, the website address repeat processing module 69 may also supplement launch page website addresses in the list of launch page website addresses according to the scores of the historical record website addresses and the scores of the favorite website addresses, so that the number of launch page website addresses in the final list of launch page website addresses reaches the set number of launch page website addresses in the web browser launch page. Here, historical record website addresses other than the deleted historical record website addresses and the favorite website addresses are set in the list of launch page website addresses in the web browser launch page in a descending order of the scores, where the scores of the supplemented historical record website addresses and the favorite website addresses should be less than those of the deleted historical record website addresses.

Finally, the launch page generating module 65 generates a browser launch page according to the list of launch page website addresses determined by the list determination module 64 and the website address repeat processing module 69, and in this way, the web browser launch page generating apparatus 60 in this preferred embodiment completes the whole browser launch page generating process.

The web browser launch page generating apparatus in this preferred embodiment, on the basis of the second preferred embodiment of the web browser launch page generating apparatus, uses a website address repeat processing module to delete and supplement launch page website addresses in a personalized launch page. Meanwhile, an error is avoided in the generation of the web browser launch page by using a default processing module, so as to make the generation of the web browser launch page more intelligent.

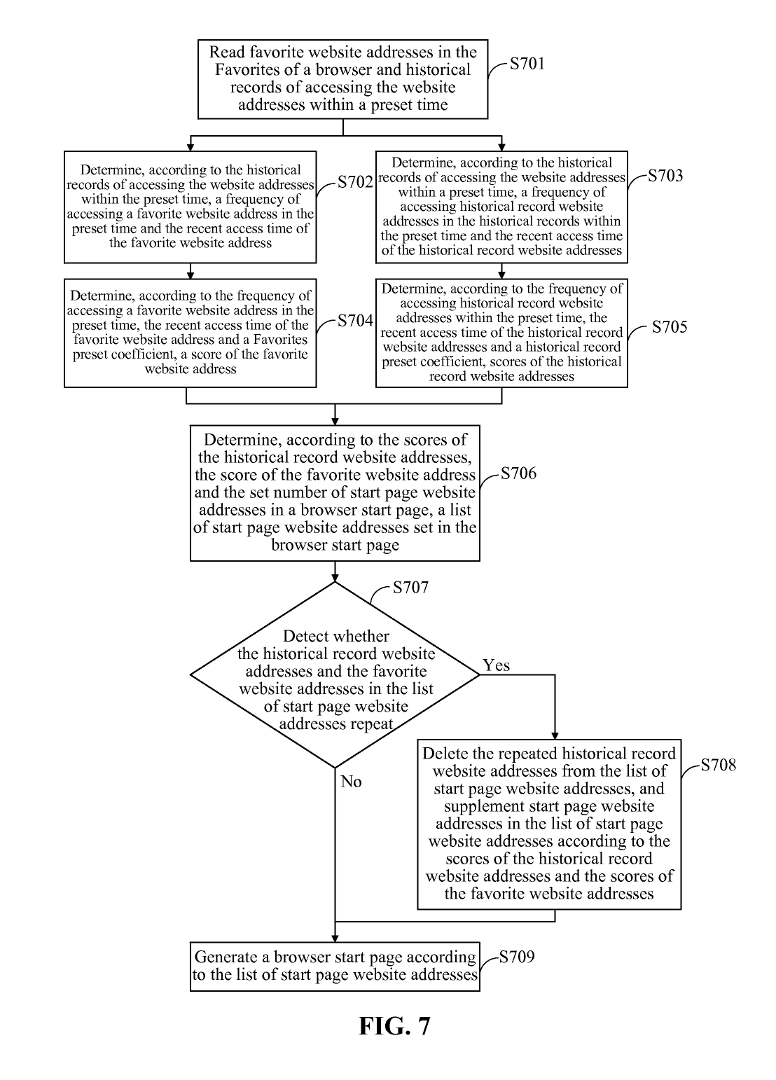

FIG. 7 is a flow chart of a third preferred embodiment of the web browser launch page generating method according to some embodiments of the present application. Referring to FIG. 6 and FIG. 7, the web browser launch page generating method in this preferred embodiment includes the following steps.

Step S701: Read favorite website addresses in the Favorites of a browser and historical records of accessing the website addresses within a predefined time period.

Step S702: Determine, according to the historical records of accessing the website addresses within the predefined time period, a frequency of accessing a favorite website address in the predefined time period and the recent access time of the favorite website address.

Step S703: Determine, according to the historical records of accessing the website addresses within a predefined time period, a frequency of accessing historical record website addresses in the historical records within the predefined time period and the recent access time of the historical record website addresses.

Step S704: Determine, according to the frequency of accessing the favorite website address in the predefined time period, the recent access time of the favorite website address and a Favorites preset coefficient, a score of the favorite website address.

Step S705: Determine, according to the frequency of accessing historical record website addresses within the predefined time period, the recent access time of the historical record website addresses and a historical record preset coefficient, scores of the historical record website addresses.

Step S706: Determine, according to the scores of the historical record website addresses, the score of the favorite website address and the set number of launch page website addresses in a browser launch page, a list of launch page website addresses set in the web browser launch page.

Step S707: Detect whether historical record website addresses and the favorite website addresses in the list of launch page website addresses repeat; if yes, perform step S708 if yes, if not, perform step S709.

Step S708: Delete the repeated historical record website addresses from the list of launch page website addresses, and supplement launch page website addresses in the list of launch page website addresses according to the scores of the historical record website addresses and the scores of the favorite website addresses.

Step S709: Generate a browser launch page according to the list of launch page website addresses.

The web browser launch page generating method according to this preferred embodiment ends at step S709.

Steps of the web browser launch page generating method according to this preferred embodiment are described below in detail.

The principle of step S701 is identical with or similar to that in step S501 of the first preferred embodiment of the web browser launch page generating method; please refer to relevant description in step S501 of the first preferred embodiment of the web browser launch page generating method for details.

The principle of step S702 is identical with or similar to that in step S502 of the first preferred embodiment of the web browser launch page generating method; please refer to relevant description in step S502 of the first preferred embodiment of the web browser launch page generating method for details.

The principle of step S703 is identical with or similar to that in step S503 of the first preferred embodiment of the web browser launch page generating method; please refer to relevant description in step S503 of the first preferred embodiment of the web browser launch page generating method for details.

The principle of step S704 is identical with or similar to that in step S504 of the first preferred embodiment of the web browser launch page generating method; please refer to relevant description in step S504 of the first preferred embodiment of the web browser launch page generating method for details.

The principle of step S705 is identical with or similar to that in step S505 of the first preferred embodiment of the web browser launch page generating method; please refer to relevant description in step S505 of the first preferred embodiment of the web browser launch page generating method for details.

The principle of step S706 is identical with or similar to that in step S506 of the first preferred embodiment of the web browser launch page generating method; please refer to relevant description in step S506 of the first preferred embodiment of the web browser launch page generating method for details.

In step S707, the website address repeat processing module 69 detects whether historical record website addresses and the favorite website addresses in the list of launch page website addresses repeat; if yes, perform step S708, and if not, perform step S709.

In step S708, if the historical record website addresses in the list of launch page website addresses and the favorite website addresses repeat, the website address repeat processing module 69 deletes the repeated historical record website addresses from the list of launch page website addresses (as scores of the repeated historical record website addresses are generally lower than those of repeated favorite website addresses, the historical record website addresses with lower scores are deleted from the list of launch page website addresses herein), so as to avoid that repetition occurs in the launch page website addresses in the web browser launch page. Further, the website address repeat processing module 69 may also supplement launch page website addresses in the list of launch page website addresses according to the scores of the historical record website addresses and the scores of the favorite website addresses, so that the number of launch page website addresses in the final list of launch page website addresses reaches the set number of launch page website addresses in the web browser launch page. Here, historical record website addresses other than the deleted historical record website addresses and the favorite website addresses are set in the list of launch page website addresses in the web browser launch page in a descending order of the scores, where the scores of the supplemented historical record website addresses and the favorite website addresses should be less than those of the deleted historical record website addresses.

Then step S709 is performed.

In step S709, the launch page generating module 65 generates a browser launch page according to the list of launch page website addresses determined by the list determination module 64 and the website address repeat processing module 69.

In this way, the whole browser launch page generating process in this preferred embodiment is completed.

Preferably, if, in step S701, the reading module 61 reads that the favorite website addresses in the Favorites of the browser or the historical records of accessing the website addresses within the predefined time period are empty, the default processing module 68 generates a default browser launch page or a blank page. As the favorite website addresses in the Favorites of the browser or the historical records of accessing the website addresses within the predefined time period being empty will result in that the scores of the favorite website addresses cannot be acquired, the configuration of the default processing module 68 can avoid an error in the generation of a browser launch page when the above situation takes place.

The web browser launch page generating method in this preferred embodiment, on the basis of the second preferred embodiment of the web browser launch page generating method, uses a website address repeat processing module to delete and supplement launch page website addresses in a personalized launch page. Meanwhile, an error is avoided in the generation of the web browser launch page by using a default processing module, so as to make the generation of the web browser launch page more intelligent.

The web browser launch page generating method and browser launch page generating apparatus according to the embodiments of present application determine, according to access frequency parameters and access time parameters related to favorite website addresses and historical record website addresses, launch page website addresses in a browser launch page, which solves the technical problem that the existing browser launch page generating method and generating apparatus reduce webpage browsing efficiency of a user.

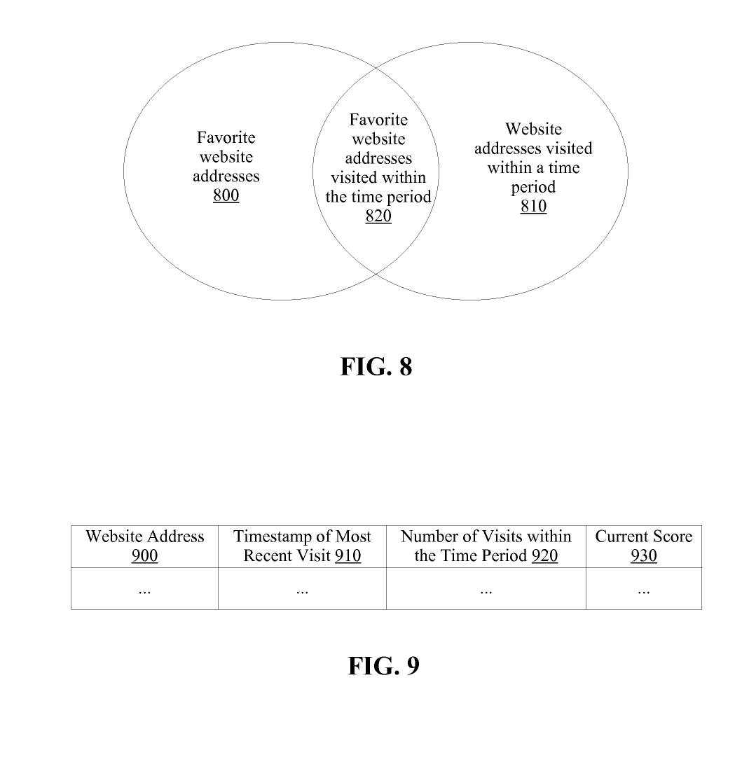

FIG. 8 is a schematic block diagram illustrating the relationship between two sets of website addresses associated with a web browser application according to some embodiments of the present application. In some embodiments, the web browser application identifies two sets of website addresses. One set of website addresses are favorite website addresses 800, which are specifically chosen by a user and marked as “Favorite website address.” For example, a user may like to check the weather condition of his or her hometown every now and then. In this case, the user may define a website address by providing his or her hometown's name and/or postal code to a website that provides weather forecasting service and then save this website address as a favorite website address. The other set of website addresses are website addresses 810 visited within a predefined time period ranging from, e.g., a day to a few months. The web browser application typically maintains a log file tracking the websites visited by the user. Naturally, some of the website addresses visited by the user during the predefined time are also in the set of favorite website addresses 800, which correspond to the set of favorite website addresses visited within the time period 820. Therefore, the web browser application can determine a set of favorite website addresses visited by the user during the predefined time period by cross-correlating the set of favorite website addresses defined by the user with the set of website addresses visited by the user during the predefined time period.

As noted above, one goal of the present application is to identify a set of website addresses to be shown in the launch page when a user starts the web browser application. In some embodiments, the location of a website address appearing in the launch page is determined by a score of the website address. As noted above, the score is determined, at least in part, based on a parameter given to favorite website addresses, a difference between the current time and the timestamp of the most recent visit to the website address by the user and a visiting frequency of the website address by the user. In some other embodiments, the score of the website address is further dependent on a pre-existing score associated with the website address. The pre-existing score may be a default value if it is the first time that the website address is to be shown in the launch page. Alternatively, the pre-existing score varies over time based on the user's activities at the website such that a new score is determined for a website address in the launch page whenever the user starts the web browser application or visits the website address through the web browser application.

FIG. 9 is a schematic block diagram illustrating a data structure (e.g., a table) for storing website address related information used for determining the score for each website address that may be displayed in the launch page. In other words, the table may include members from the set of favorite website addresses 800 or the set of website addresses 810 visited within the time period. For each entry, there is a website address 900 (e.g., a URL), which may also include a name given to the website address by the user, a timestamp 910 of most recent visit to the website address by the user, a number of visits 920 within the time period, and a current score 930 of the website address. As explained above, the timestamp 910 of most recent visit is used to compare with the current timestamp and the difference between two timestamps is used for weighting the score such that more recently-visited website address receives a higher weight. Similarly, the number of visits 920 within the time period is used for determining a visiting frequency of the website address by the user. A higher visiting frequency indicates that there is a higher chance that the user may visit the website address again in the near future. Accordingly, the website address is given a higher score. Finally, the current score 930 is used as the basis for determining a new score for the website address because the current score reflects the user's interest in this website address during a long period of time beyond the predefined time period for logging the user's browsing history. For example, a user may sometimes clear his or her browsing history data such that the set of website addresses 810 visited within the period becomes empty. In this case, the current score of a website address may still exist and can be used for indicating the popularity of the website address. For a website address that the user visits for the first time, the web browser application may assign a default score to the website address. Similarly, if the website address is then marked as a favorite website address, the default score should be updated accordingly to reflect this user decision.

After generating a new score for each of the favorite website addresses 820, the web browser application displays them in the launch page in an order consistent with their respective newly-generated scores. A website address of a higher score is assumed to be more popular and is therefore positioned close to the top or at a more visible position in the launch page. Note that a website address (e.g., a URL) is often displayed in the form of a hyperlink along with an icon of the website address, which may be a thumbnail image of the web page identified by the website address during the last visit of the website address by the user. A user selection of the icon causes the web browser application to open a new window and to render a web page retrieved from the website address in the new window.

In some embodiments, the number of favorite website addresses visited by the user during the time period 820 is large enough such that they themselves can occupy the entire launch page assuming that there are a fixed number of spots in the launch page for displaying the popular website addresses. In some other embodiments, the number of favorite website addresses visited by the user during the time period 820 may not be sufficient to cover the entire launch page such that there is still room left in the launch page after displaying the set of favorite website addresses visited by the user during the predefined time period 820. In this case, the web browser application may look for more candidates from either the set of favorite website addresses 800 or the set of website addresses visited by the user during the time period 810 to fill the blank spots in the launch page.

For example, the web browser application may generate new scores for a second set of website addresses visited by the user during the predefined time period based on their associated timestamps, numbers of visits, and current scores. Although these website addresses are not in the set of favorite website addresses, it may be desirable to display at least some of them in the launch page if the user's activities with these website addresses justify such treatment. Typically, the location of the second set of website addresses visited by the user during the predefined time period as displayed in the launch page should be below the set of favorite website addresses visited by the user during the predefined time period 820. In some embodiments, it is possible that some of the website addresses in the second set may have a higher score and therefore be displayed before at least one of the set of the favorite website addresses visited by the user during the predefined time period 820.

Similarly, candidates for filling the empty spots in the launch page may come from the set of favorite website addresses even if they are not appearing in the set 820. In this case, the web browser application may generate new scores for a third set of favorite website addresses defined by the user but not within the set of favorite website addresses visited by the user during the predefined time period 820 based on their associated current scores. Given the nature of the set of favorite website addresses, it may be desirable to display at least some of them in the launch page if there is any empty spot. Typically, the location of the third set of favorite website addresses displayed in the launch page should be below the set of favorite website addresses visited by the user during the predefined time period 820. In some embodiments, it is possible that some of favorite website addresses in the third set may have a higher score and therefore be displayed before at least one of the set of the favorite website addresses visited by the user during the predefined time period 820.

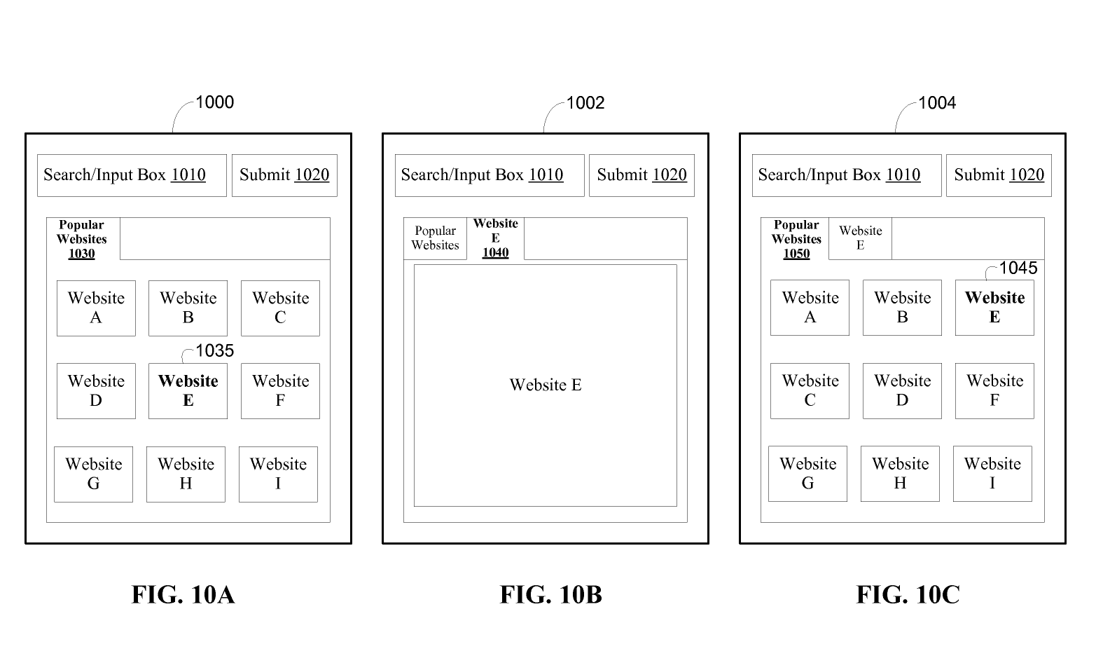

FIGS. 10A-10C are screenshots illustrating how a web browser launch page is generated and updated according to some embodiments of the present application. As noted above, a website address's score is dynamic and it varies over time based on the user activities on the website address. In this example, the screenshot 1000 in FIG. 10A depicts the launch page of a web browser application after the user starts the application. The web browser application usually includes a search/input box 1010 through which a user can either enter one or more search terms or a website address (e.g., a URL). By pressing the Submit button 1020, the user can submit a search query to a search engine to a website address to a web server.

The launch page named “Popular Websites” 1030 includes a 3×3 2D array of icons, each icon corresponding to a respective popular website from Website A to Website I. In response to a user selection of the icon 1035 corresponding to Website E, the web browser application retrieves a web page from the user-selected website address Website E and creates a new window for displaying the web page. As shown in FIG. 10B, the new window has a title “Website E” 1040 and it covers the launch page 1030 such that only the title of the launch page “Popular Websites” is still visible in the screenshot 1002. But as noted above, the user selection of the website address “Website E” triggers the web browser application to recalculate the scores of the website addresses in the launch page and . As a result, the web browser application updates the timestamp, the number of visits, and the current score of the user-selected website address in accordance with the user selection. When the user subsequently clicks on the title of the launch page, the launch page “Popular Websites” is brought back to cover the web page “Website E” 1040. In this particular example, because of the update of the score of the website address “Website E,” it takes over the spot 1045 and pushes the website address “Website C” to the second row in the launch page “Popular Websites” 1050. In other words, in response to the user selection of the launch page, the web browser application re-orders the set of favorite website addresses displayed in the first window of the web browser application in accordance with at least the updated current score of the user-selected website address “Website E.”

To sum up, the present application has been disclosed through preferred embodiments, but the preferred embodiments are not intended to limit the present application. Various variations and modifications made by persons of ordinary skill in the art without departing from the spirit and scope of the present application fall within the protection scope of the present application as defined by the appended claims.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
at a computer having one or more processors and memory:
receiving a user input to start a web browser application;
in response to the user input:
identifying a set of favorite website addresses defined by the user and a set of website addresses visited by the user during a predefined time period;
determining a set of favorite website addresses visited by the user during the predefined time period by cross-correlating the set of favorite website addresses defined by the user with the set of website addresses visited by the user during the predefined time period;
for each favorite website address visited by the user during the predefined time period:
determining a timestamp of a most recent visit by the user, a number of visits by the user during the predefined time period, and a current score of the favorite website address; and
generating a new score for the favorite website address based, at least in part, on the timestamp, the number of visits, and the current score; and
displaying the set of favorite website addresses visited by the user during the predefined time period in a first window of the web browser application in an order consistent with their respective newly-generated scores.

2. The method of claim 1, further comprising:
receiving a user selection of one of the set of favorite website addresses displayed in the first window of the web browser application;
in response to the user selection:
retrieving a web page from the user-selected website address;
covering at least a portion of the first window of the web browser application with a second window of the web browser application including the retrieved web page; and
updating the timestamp, the number of visits, and the current score of the user-selected website address in accordance with the user selection.

3. The method of claim 2, further comprising:
receiving a user selection of the first window;
in response to the user selection:
re-ordering the set of favorite website addresses displayed in the first window of the web browser application in accordance with at least the updated current score of the user-selected website address; and
covering at least a portion of the second window of the web browser application with the first window of the web browser application including the set of re-ordered favorite website addresses.

4. The method of claim 1, further comprising:
when there is room left in the first window of the web browser application after displaying the set of favorite website addresses visited by the user during the predefined time period:
generating new scores for a second set of website addresses visited by the user during the predefined time period based on their associated timestamps, numbers of visits, and current scores; and
displaying the second set of website addresses visited by the user during the predefined time period in the first window of the web browser application in an order consistent with their respective newly-generated scores.

5. The method of claim 4, wherein the second set of website addresses visited by the user during the predefined time period is displayed below the set of favorite website addresses visited by the user during the predefined time period in the first window of the web browser application.

6. The method of claim 1, further comprising:
when there is room left in the first window of the web browser application after displaying the set of favorite website addresses visited by the user during the predefined time period:
generating new scores for a third set of favorite website addresses that are within the set of favorite website addresses defined by the user but not within the set of favorite website addresses visited by the user during the predefined time period based on their associated current scores; and
displaying the third set of favorite website addresses in the first window of the web browser application in an order consistent with their respective newly-generated scores.

7. The method of claim 6, wherein the third set of favorite website addresses is displayed below the set of favorite website addresses visited by the user during the predefined time period in the first window of the web browser application.

8. A computer system, comprising:
one or more processors;
memory; and
one or more programs stored in the memory and to be executed by the one or more processors, the one or more programs comprising instructions for:
receiving a user input to start a web browser application;
in response to the user input:
identifying a set of favorite website addresses defined by the user and a set of website addresses visited by the user during a predefined time period;
determining a set of favorite website addresses visited by the user during the predefined time period by cross-correlating the set of favorite website addresses defined by the user with the set of website addresses visited by the user during the predefined time period;
for each favorite website address visited by the user during the predefined time period:
determining a timestamp of a most recent visit by the user, a number of visits by the user during the predefined time period, and a current score of the favorite website address; and
generating a new score for the favorite website address based, at least in part, on the timestamp, the number of visits, and the current score; and
displaying the set of favorite website addresses visited by the user during the predefined time period in a first window of the web browser application in an order consistent with their respective newly-generated scores.

9. The computer system of claim 8, wherein the one or more programs further include instructions for:
receiving a user selection of one of the set of favorite website addresses displayed in the first window of the web browser application;
in response to the user selection:
retrieving a web page from the user-selected website address;
covering at least a portion of the first window of the web browser application with a second window of the web browser application including the retrieved web page; and
updating the timestamp, the number of visits, and the current score of the user-selected website address in accordance with the user selection.

10. The computer system of claim 9, wherein the one or more programs further include instructions for:
receiving a user selection of the first window;
in response to the user selection:
re-ordering the set of favorite website addresses displayed in the first window of the web browser application in accordance with at least the updated current score of the user-selected website address; and
covering at least a portion of the second window of the web browser application with the first window of the web browser application including the set of re-ordered favorite website addresses.

11. The computer system of claim 8, wherein the one or more programs further include instructions for:
when there is room left in the first window of the web browser application after displaying the set of favorite website addresses visited by the user during the predefined time period:
generating new scores for a second set of website addresses visited by the user during the predefined time period based on their associated timestamps, numbers of visits, and current scores; and
displaying the second set of website addresses visited by the user during the predefined time period in the first window of the web browser application in an order consistent with their respective newly-generated scores.

12. The computer system of claim 11, wherein the second set of website addresses visited by the user during the predefined time period is displayed below the set of favorite website addresses visited by the user during the predefined time period in the first window of the web browser application.

13. The computer system of claim 8, wherein the one or more programs further include instructions for:
when there is room left in the first window of the web browser application after displaying the set of favorite website addresses visited by the user during the predefined time period:
generating new scores for a third set of favorite website addresses that are within the set of favorite website addresses defined by the user but not within the set of favorite website addresses visited by the user during the predefined time period based on their associated current scores; and
displaying the third set of favorite website addresses in the first window of the web browser application in an order consistent with their respective newly-generated scores.

14. The computer system of claim 13, wherein the third set of favorite website addresses is displayed below the set of favorite website addresses visited by the user during the predefined time period in the first window of the web browser application.

15. A non-transitory computer readable storage medium storing one or more programs, the one or more programs comprising instructions, which, when executed by a mobile device having one or more processors and a display, cause the mobile device to perform operations including:
receiving a user input to start a web browser application;
in response to the user input:
identifying a set of favorite website addresses defined by the user and a set of website addresses visited by the user during a predefined time period;
determining a set of favorite website addresses visited by the user during the predefined time period by cross-correlating the set of favorite website addresses defined by the user with the set of website addresses visited by the user during the predefined time period;
for each favorite website address visited by the user during the predefined time period:
determining a timestamp of a most recent visit by the user, a number of visits by the user during the predefined time period, and a current score of the favorite website address; and
generating a new score for the favorite website address based, at least in part, on the timestamp, the number of visits, and the current score; and
displaying the set of favorite website addresses visited by the user during the predefined time period in a first window of the web browser application in an order consistent with their respective newly-generated scores.

16. The non-transitory computer readable storage medium of claim 15, wherein the one or more programs further include instructions for:
receiving a user selection of one of the set of favorite website addresses displayed in the first window of the web browser application;
in response to the user selection:
retrieving a web page from the user-selected website address;
covering at least a portion of the first window of the web browser application with a second window of the web browser application including the retrieved web page; and
updating the timestamp, the number of visits, and the current score of the user-selected website address in accordance with the user selection.

17. The non-transitory computer readable storage medium of claim 16, wherein the one or more programs further include instructions for:
receiving a user selection of the first window;
in response to the user selection:
re-ordering the set of favorite website addresses displayed in the first window of the web browser application in accordance with at least the updated current score of the user-selected website address; and
covering at least a portion of the second window of the web browser application with the first window of the web browser application including the set of re-ordered favorite website addresses.

18. The non-transitory computer readable storage medium of claim 15, wherein the one or more programs further include instructions for:
when there is room left in the first window of the web browser application after displaying the set of favorite website addresses visited by the user during the predefined time period:
generating new scores for a second set of website addresses visited by the user during the predefined time period based on their associated timestamps, numbers of visits, and current scores; and
displaying the second set of website addresses visited by the user during the predefined time period in the first window of the web browser application in an order consistent with their respective newly-generated scores.

19. The non-transitory computer readable storage medium of claim 18, wherein the second set of website addresses visited by the user during the predefined time period is displayed below the set of favorite website addresses visited by the user during the predefined time period in the first window of the web browser application.

20. The non-transitory computer readable storage medium of claim 15, wherein the one or more programs further include instructions for:
when there is room left in the first window of the web browser application after displaying the set of favorite website addresses visited by the user during the predefined time period:
generating new scores for a third set of favorite website addresses that are within the set of favorite website addresses defined by the user but not within the set of favorite website addresses visited by the user during the predefined time period based on their associated current scores; and
displaying the third set of favorite website addresses in the first window of the web browser application in an order consistent with their respective newly-generated scores.
